(19) United States
(12) Patent Application Publication
(10) Pub. No.: US 2017/0273291 A1
(43) Pub. Date: Sep. 28, 2017

(54) INSECT CAPTURING DEVICE HAVING IMAGING FUNCTION FOR HARMFUL INSECT INFORMATION MANAGEMENT

(71) Applicants: E-TND CO., LTD., Gwangju-si Gyeonggi-do (KR); SUMJEAN E&IT, Seoul (KR)

(72) Inventors: Jae-seung YOO, Gwangju-si Gyeonggi-do (KR); Long-jin JUNG, Seoul (KR); Dong-sik RYU, Seoul (KR); Jun-soo KIM, Seoul (KR)

(73) Assignees: E-TND CO., LTD.; SUMJEAN E&IT

(21) Appl. No.: 15/619,558

(22) Filed: Jun. 12, 2017

Related U.S. Application Data
(63) Continuation of application No. PCT/KR2015/013632, filed on Dec. 11, 2015.

(30) Foreign Application Priority Data
Dec. 12, 2014 (KR) 10-2014-0179588

(51) Int. Cl. A01M 1/06; G06F 19/00; G06K 9/46

(52) U.S. Cl. CPC A01M 1/06; G06K 9/46; G06F 19/00; G06K 9/00

(57) ABSTRACT

An insect capturing device having an imaging function for harmful insect information management, according to the present invention, comprises: a collection unit having a collection net so as to collect harmful insects, and having a passage tube, provided on one side of the collection net, through which the collected harmful insects pass; a support unit provided on the other side of the collection unit so as to support the collection unit; a capturing analyzer having an outer filter connected to the collection unit through the passage tube so as to separate moisture from air introduced with the harmful insects, an inner filter connected to the outer filter and maintaining constant temperature and humidity conditions, a capturing tube unit connected to the inner filter and having a count sensor for sensing the harmful insects having passed there through and counting the number of harmful insects, and a gathering unit connected to the capturing tube unit and having a gathering net for enabling the harmful insects suctioned in and moved through the capturing tube unit to be finally filtered; an imaging unit provided at a position aimed at the gathering unit in the capturing tube unit, and photographing harmful insects being moved to the upper part of the gathering net; and a capture unit provided between the imaging unit and the gathering net such that the imaging unit obtains images of the harmful insects suctioned in and moved through the capturing tube unit, and enabling the harmful insects to be temporarily filtered before being filtered in the gathering net. Therefore, it is possible to provide an insect capturing device having an imaging function for harmful insect information management, the device simply classifying and analyzing harmful insects according to the occurrence frequency and types of the harmful insects by easily obtaining, in real time, without an expensive high speed camera, images of harmful insects collected in the insect capturing device for collecting harmful insects such as flies or mosquitoes.

### CROSS-REFERENCES TO RELATED APPLICATIONS

This Application claims the benefit of priority and is a Continuation application of the prior International Patent Application No. PCT/KR2015/013632, with an international filing date of Dec. 11, 2015, which designated the United States, and is related to the Korean Patent Application No. 10-2014-0179588, filed Dec. 12, 2014, the entire disclosures of all applications are expressly incorporated by reference in their entirety herein.

### BACKGROUND OF THE INVENTION

### 1. Field of the Invention

The present invention relates to an insect capturing device having an imaging function for insect information management, and more particularly, to an insect capturing device having an imaging function that is capable of remotely managing count information and image information on harmful insects such as flies or mosquitoes which are collected.

### 2. Description of Related Art

Generally, harmful insects are collected using an insect capturing device to check the population density of harmful insects such as flies and mosquitoes, which carry infectious diseases or damage crops, and to investigate whether the harmful insects are infected by pathogenic bacteria.

An example of such an insect capturing device is disclosed in Korean Patent No. 10-1003178 (registered on Dec. 15, 2010, hereinafter referred to as “Patent Document 1”).

However, the conventional insect capturing device cannot perform a capturing function smoothly in poor weather conditions such as on windy or rainy days.

Further, in conventional cases, since a surveyor should visit the site where the capturing device is installed to collect the count information, image information, and other information on the harmful insects collected in the capturing device or to maintain the capturing device, a lot of labor is required to collect information of harmful insects or maintain the capturing device.

In addition, analyzing the number and type of harmful insects by capturing images of the harmful insects collected through the insect capturing device in a suction manner requires an expensive high-speed camera for imaging the harmful insects because the speed of movement of the harmful insects is excessively high at the moment of suction. Thereby, there are cost problems and technical problems according to actual application of a high-speed camera.

### BRIEF SUMMARY OF THE INVENTION

Therefore, the present invention has been made in view of the above problems, and it is one object of the present invention to provide an insect capturing device having an imaging function for insect information management which is capable of easily acquiring images of harmful insects such as flies and mosquitoes captured in the capturing device in real time without an expensive high-speed camera such that classification and analysis of the harmful insects by frequency of occurrence and kind can be easily performed.

In accordance with one aspect of the present invention, provided is an insect capturing device having a imaging function for harmful insect information management, the insect capturing device including: a collection unit having a collection net for collecting harmful insects, one side of the collection net being provided with a passage tube through which the collected harmful insects pass; a support provided on the other side of the collection unit to support the collection unit; a capturing analyzer including an outer filter connected to the collection unit through the passage tube to separate moisture from air introduced together with the harmful insects, an inner filter connected to the outer filter and configured to maintain constant temperature and humidity conditions, a capturing tube unit connected to the inner filter and provided with a counting sensor for sensing the harmful insects passing therethrough and counting the number of the harmful insects, and a catch unit connected to the capturing tube unit and provided with a catch net so as to finally filter out the harmful insects suctioned and moved through the capturing tube unit; an imaging unit provided at a position in the capturing tube unit facing the catch unit; and a capture unit provided between the imaging unit and the catch net to temporarily filter out the harmful insects suctioned and moved through the capturing tube unit so as to acquire an image of the harmful insects before the harmful insects are filtered by the catch net.

Preferably, the capture unit includes a rotatable net provided to the capturing tube unit so as to rotate at a certain frequency, and a rotation drive unit for rotatably driving the rotatable net.

Preferably, the imaging unit includes an imaging camera for performing imaging at predetermined time intervals according to the certain frequency of rotation of the rotatable net, and an illumination lamp arranged around the imaging camera.

Preferably, the capturing analyzer includes a first communication unit for transmitting, by wired/wireless communication, count information and image information on the harmful insects acquired from the imaging unit, the insect capturing device further including a server including a second communication unit for receiving, by wired/wireless communication, the count information and image information on the harmful insects transmitted from the first communication unit, and a memory unit for receiving and storing the information received from the second communication unit.

Preferably, the second communication unit transmits the count information and the image information on the harmful insects stored in the memory unit, the insect capturing device further including a server including a third communication unit for receiving, by wired/wireless communication, the count information and the image information on the harmful insects transmitted from the second communication unit, and a display unit for outputting an image corresponding to the information received from the third communication unit.

Preferably, the capturing tube unit includes a guide tube for guiding movement of the harmful insects, wherein the counting sensor is provided inside the guide tube, and the guide tube is formed of a transparent material.

As apparent from the fore-going, with an insect capturing device having an imaging function for insect information management according to embodiments of the present invention, images of harmful insects such as flies and mosquitoes captured in the capturing device may be easily acquired in real time without an expensive high-speed camera such that classification and analysis of the harmful insects by frequency of occurrence and kind can be easily performed.

### BRIEF DESCRIPTION OF THE DRAWINGS

FIG. 1 is a side view of a smart collection body of an insect capturing device having an imaging function for harmful insect information management according to an embodiment of the present invention.

FIG. 2 is a perspective view of a collection net frame of the collection unit of FIG. 1.

FIG. 3 is a conceptual diagram of the capturing analyzer of FIG. 1.

FIG. 4 is a cross-sectional view of the outer filter of FIG. 3.

FIG. 5 is a cross-sectional view of the inner filter of FIG. 3.

FIG. 6 is a cross-sectional view of the capturing tube unit of FIG. 3.

FIG. 7 is a perspective view of a part of the imaging camera and capture unit of FIG. 6 viewed from above.

FIG. 8 is a cross-sectional view of the catch unit of FIG. 3.

FIG. 9 is a control block diagram of an insect capturing device having an imaging function for harmful insect information management according to an embodiment of the present invention.

FIG. 10 is a system block diagram illustrating a system in which smart collection bodies of an insect capturing device having an imaging function for harmful insect information management according to the present invention are provided in each region and are remotely monitored and measured through a server.

FIG. 11 is a general conceptual diagram of an insect capturing device having an imaging function for harmful insect information management according to an embodiment of the present invention.

### DETAILED DESCRIPTION OF THE INVENTION

Hereinafter, the present invention will be described in detail with reference to the accompanying drawings.

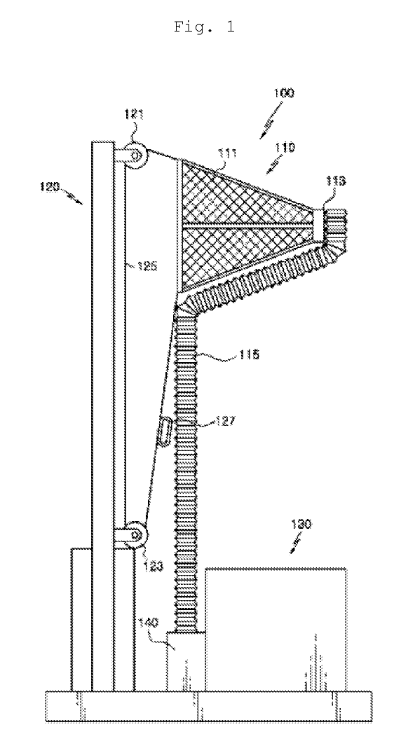

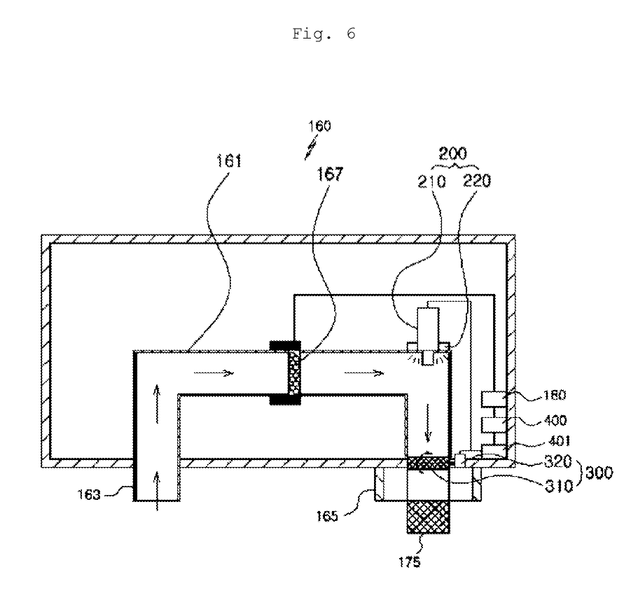

As shown in FIGS. 1 and 6, an insect capturing device having an imaging function for harmful insect information management according to the present invention includes a smart collection body 100, an imaging unit 200, and a capture unit 300.

As shown in FIG. 1, the smart collection body 100, which may collect and contain harmful insects such as flies and mosquitoes and generate count information and image information on the collected harmful insects, includes a collection unit 110, a support 120, and a capturing analyzer 130.

The installation position of the smart collection body 100 is not particularly limited. For example, the smart collection body 100 may be installed on a mounting surface such as a concrete floor so as to firmly fix the support 120 and the capturing analyzer 130, which are vertically installed on the mounting surface.

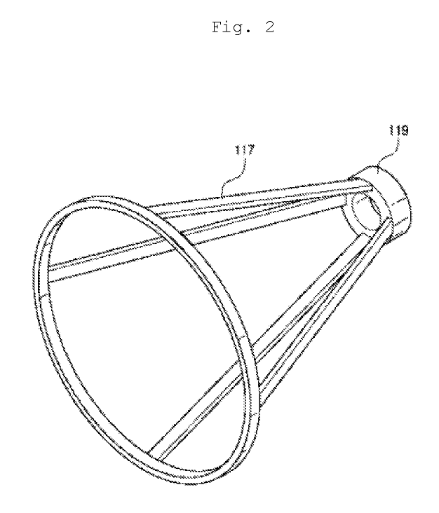

As shown in FIGS. 1 and 2, the collection unit 110 includes a collection net 111 supported by the support 120 on one side thereof so as to collect harmful insects flying in the air and send the collected harmful insects into a discharge hole 113 formed on the other side, a passage tube 115 arranged to communicate with the discharge hole 113 of the collection net 111 to allow the collected harmful insects to pass therethrough, a collection net frame 117 and a communication hole 119.

The collection net 111 is formed in a net structure to collect harmful insects entering thereinto through the open front thereof.

As shown in FIG. 2, the collection net frame 117 is formed in a funnel shape to surround the collection net 111. The collection net frame 117 may form an exoskeleton of the collection net 111 by being coupled to the outer surface of the collection net 111 so as to secure a predetermined space in the collection net 111 and may include a communication hole 119.

That is, the collection net frame 117 functions to hold the collection net 111 from the outside such that the collection net 111 can maintain a certain shape. Therefore, even when a strong wind blows, the predetermined space may be secured in the collection net 111, and thus harmful insects may be smoothly collected.

The communication hole 119 is provided in the rear surface of the collection net frame 117 such that the discharge hole 113 of the collection net 111 and the passage tube 115 can communicate with each other. More specifically, the discharge hole 113 of the collection net 111 may be inserted into and coupled to the communication hole 119, and the communication hole 119 may be coupled to the passage tube 115. Thereby, the discharge hole 113 of the collection net 111 and the passage tube 115 may communicate with each other.

The passage tube 115 provides a passageway that is connected to the discharge hole 113 to allow the harmful insects collected by the collection net 111 to be sent to the capturing analyzer 130, as shown in FIG. 1.

As shown in FIG. 1, the support 120 has a lower portion fixedly mounted on a concrete floor and is extended vertically upward in a pillar shape such that the collecting unit 110 is firmly supported without collapsing. The support 120 is provided to the other side of the collecting unit 110 to support the collecting unit 110, and includes an upper pulley 121, a lower pulley 123, a wire rope 125, and a handle 127.

The upper pulley 121 is rotatably installed on the upper portion of the support 120 and the lower pulley 123 is rotatably installed on the lower portion of the support 120.

Preferably, according to an embodiment, the upper pulley 121 is rotatably installed on the upper portion of the support 120 so as to be positioned higher than the collection net 111 and the lower pulley 123 is rotatably installed on the lower portion of the support 120 so as to be positioned lower than the collection net 111.

One end of the wire rope 125 is fixed to the upper end portion of the collection net 111 and the other end of the wire rope 125 is fixed to the lower end portion of the collection net 111. The middle portion between the one end and the other end of the wire rope 125 may be sequentially wound around the upper pulley 121 and the lower pulley 123, starting from the upper end portion of the collection net 111, and then may extend to the lower end of the collection net 111. The handle 127 may be fixed to the wire rope 125.

The handle 127 is fixed to the middle portion of the wire rope 125 and may provide a grip portion that can be gripped by the user's hand.

Accordingly, as the wire rope 125 and the collection net frame 117 are combined with each other, the wire rope 125 and the collection unit 110 may be operatively connected with each other, the collection unit 110 and the passage tube may be supported by the support 120, and the user may vertically move the collection unit 110 by holding the handle 127 and vertically moving the handle 127.

Since the collecting unit 110 is connected to the passage tube 115, the length of the passage tube 115 is also preferably adjusted when the collecting unit 110 is moved up and down. To this end, the passage tube 115 is formed in a bellows shape such that the length thereof is adjustable in the longitudinal direction.

As the passage tube 115 is formed in the bellows shape as shown in FIG. 1, the user may simultaneously adjust the installation height of the collecting unit 110 and the length of the passage tube 115 by moving the handle 127 up and down. Therefore, the height of the collection unit 110 and the length of the passage tube 115 may be adjusted according to the installation place and height of the smart collection body 100.

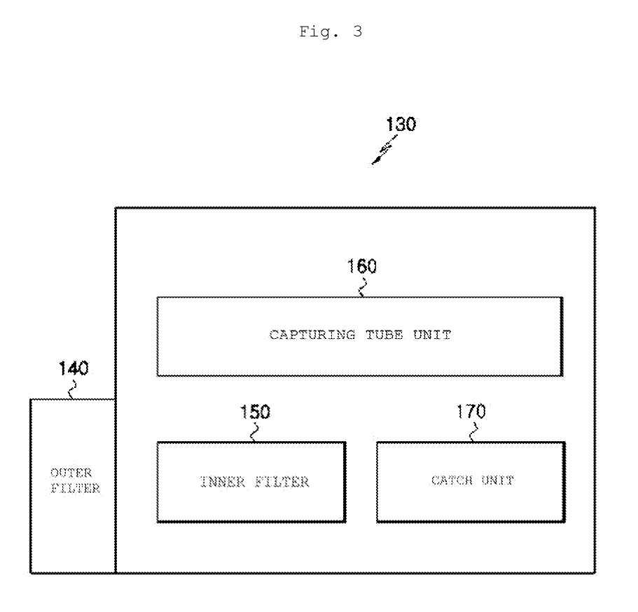

As shown in FIGS. 1 and 3, the capturing analyzer 130 includes an outer filter 140 connected to the collection unit 110 through the passage tube 115 to separate moisture from the air introduced together with harmful insects, an inner filter 150 connected to the outer filter 140 and configured to maintain constant temperature and humidity conditions, a capturing tube unit 160 connected to the inner filter 150 and provided with a counting sensor 167 for sensing the harmful insects passing therethrough and counting the number of the harmful insects, and a catch unit 170 connected to the capturing tube unit 160 and provided with a catch net 175 so as to finally filter out the harmful insects suctioned and moved through the capturing tube unit 160.

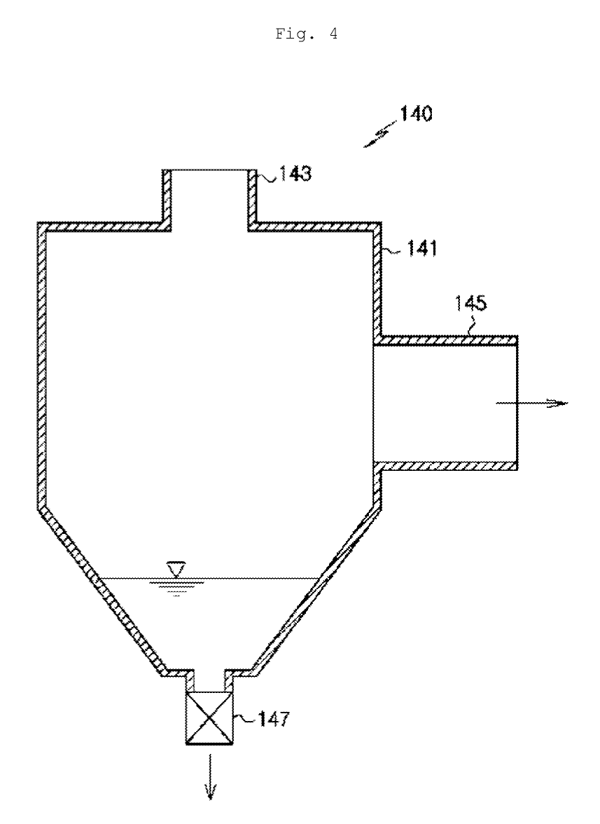

As shown in FIG. 4, the outer filter 140 is configured to separate water (mist, dew, rain, snow, etc., caused by external weather conditions) introduced thereinto together with harmful insects from the harmful insects by gravity, and includes an outer housing 141, a first introduction port 143, a first discharge port 145, and a discharge valve 147.

The outer housing 141 forms an outer appearance of the outer filter 140 and defines a predetermined separation space therein. The first introduction port 143 is connected to the passage tube 115 to provide a passage through which external water enters together with harmful insects into the separation space of the outer housing 141.

The first discharge port 145 guides the harmful insects separated from the water through the discharge valve 147 such that the harmful insects are discharged to the inner filter 150. The discharge valve 147 discharges the water separated through the outer filter 140 to the outside.

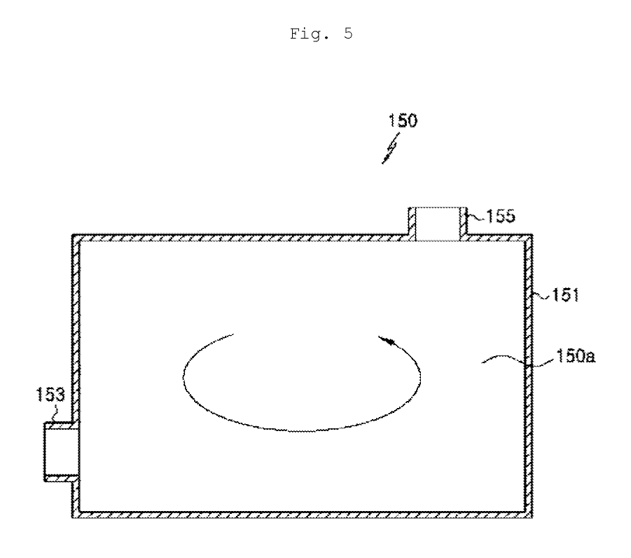

As shown in FIG. 5, the inner filter 150 is arranged to perform a constant temperature and humidity function for air introduced together with harmful insects, and includes an inner housing 151, a second introduction port 153, and a second discharge port 155.

The inner housing 151 forms an outer appearance of the inner filter 150 and a constant temperature and humidity space 150a is formed in the inner housing 151 to perform constant temperature and humidity control on the air introduced together with the harmful insects. The constant temperature and humidity space 150a may be provided with a constant temperature and humidity means such as a heater or a humidifier capable of performing a constant temperature and humidity function by controlling the temperature and humidity of the air introduced together with the harmful insects.

The second introduction port 153 is connected to the first discharge port 145 of the outer filter 140 to guide the air introduced together with the harmful insects discharged from the first discharge port 145 of the outer filter 140 into the constant temperature and humidity space 150a.

Accordingly, the air introduced through the second introduction port 153 may be discharged to the capturing tube unit 160 through the second discharge port 155 together with the harmful insects in a constant temperature and humidity state.

As shown in FIG. 6, the capturing tube unit 160 includes a guide tube 161 provided at an upper portion of the inner filter 150 to guide movement of harmful insects, a third introduction port 163 connected to the second discharge port 155 to form an inlet of the guide tube 161, a third discharge port 165 connected to the capture unit 170 to form an outlet of the guide tube 161, and a counting sensor 167 for sensing the harmful insects to count the number of the harmful insects.

In an embodiment of the present invention, the counting sensor 167 is provided inside the guide tube 161, and the guide tube 161 is preferably formed of a transparent material.

Thereby, the harmful insects collected by the smart collection body 100 can be easily visually checked from the outside. Particularly, even if the illumination lamp 220 of the image capturing unit 200, which will be described later, is installed on the outside of the guide tube 161 at the upper portion of the guide tube 161, high imaging illuminance may be provided as light is directed from the upper portion of the guide tube 161 toward the capture unit 300 through the illumination lamp 220. Thereby, imaging may be properly performed by the imaging camera 210 of the imaging unit 200, which will be described later.

The counting sensor 167 is provided with a light-emitting and light-receiving structure using an infrared LED, and distinguishes between a fly, a mosquito and other harmful insects by a passage time and size of an object which obstructs a light-emitting area and a light receiving area, and may be formed in various ways, for example, with lights arranged in one row and seven columns or in two rows and seven columns.

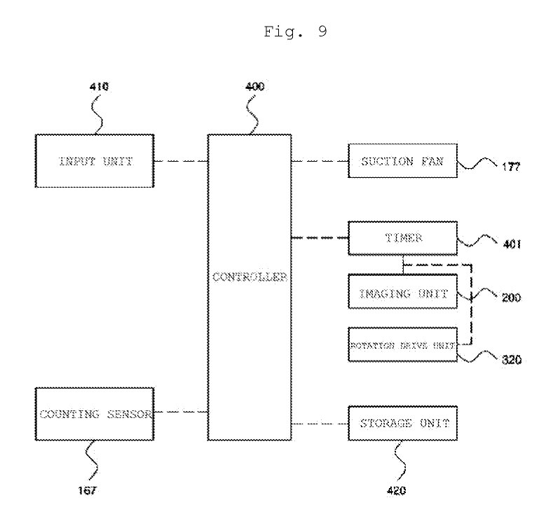

Accordingly, as shown in FIG. 9, the controller 400, which will be described later, may acquire collection information necessary for classification and analysis of the harmful insects by frequency of occurrence and counting the kinds and number of the harmful insects captured through the smart collection body 100 based on the result sensed by the counting sensor 167. Further, the controller 400 may control a suction fan 177 to adjust the collected amount or control the imaging camera 210, the illumination lamp 220, or a rotation drive unit 320 of the capture unit 300, which will be described later, based on the acquired collection information.

The type of the counting sensor 167 is not particularly limited. For example, an area beam sensor may be used.

Accordingly, the number of harmful insects collected in the smart collection body 100 of the present invention and moved through the guide tube 161 may be easily sensed and counted by the counting sensor 167, whereby data about the number of harmful insects collected in a certain area may be easily secured.

In an embodiment of the present invention, the capturing analyzer 130 preferably includes a first communication unit 180 for transmitting the count information and image information acquired from the counting sensor 167 and the imaging unit 200 through wired/wireless communication, as shown in FIG. 6.

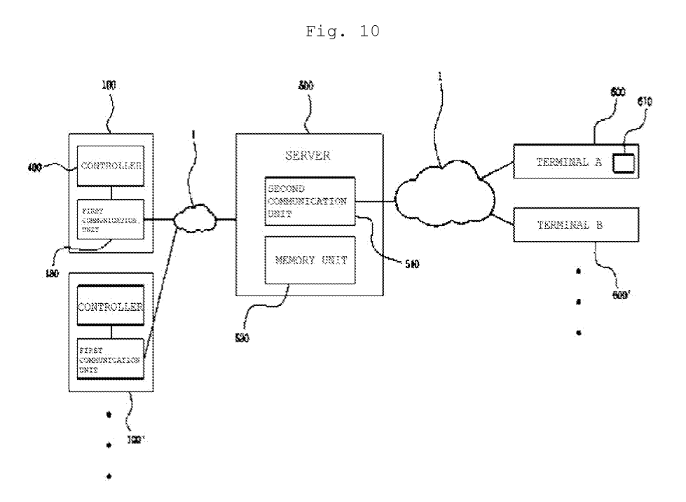

As shown in FIG. 10, the first communication unit 180 may transmit the information stored in the smart collection body 100 to the outside or receive information from the outside. For example, the first communication unit 180 may transmit the information about the harmful insects collected by the capturing tube unit 160 or may receive a control signal from the outside.

The type of the first communication unit 180 is not particularly limited and may employ wireless communication technology such as, for example, WLAN (wireless LAN) (Wi-Fi), WiBro (wireless broadband), WiMAX (world interoperability for microwave access), HSDPA (high speed downlink packet access), and LTE (long term evolution).

As shown in FIG. 6, the imaging unit 200 is provided at a position in the capturing tube unit 160 facing the catch unit 170, that is, at an upper portion of the guide tube 161 to capture images of harmful insects moved to the upper portion of the catch net 175. The imaging unit 200 includes the imaging camera 210 arranged spaced apart from the rotatable net 310 of the capture unit 300, which will be described later, on the vertical path of the upper portion of the guide tube 161 at a position where the third discharge port 165 communicates with the fourth introduction portion 173 of the catch unit 170, which will be described later, so as to perform imaging at predetermined time intervals according to a time cycle by which the rotatable net 310 is rotated, and the illumination lamp 220, such as an LED lamp, arranged around the imaging camera 210 to enhance the imaging illuminance around the imaging camera 210.

Accordingly, the harmful insects which are moved through the guide tube 161 and temporarily filtered in the rotatable net 310 of the capture unit 300 may be photographed, and thus a clear image of the harmful insects moved through the capturing tube unit 160 may be easily acquired before the four insects are filtered by the catch net 175.

The imaging camera 210 may collect image information on the harmful insects temporarily filtered by the rotatable net 310 of the capture unit 300 by photographing the harmful insects passing through the guide tube 161. Further, as light is provided from the upper portion of the guide tube 161 toward the capture unit 300 through the illumination lamp 200, the guide tube 161 is formed of transparent glass or synthetic resin so as to increase the imaging illuminance.

Accordingly, by transmitting the count information and image information on the harmful insects acquired by the counting sensor 167 and the imaging camera 210 to a server 500 and a terminal 600, which will be described later, the harmful insect information may be remotely provided to a remote site. A more detailed description thereof will be given later.

As shown in FIG. 6, the capture unit 300 is provided between the imaging unit 200 and the catch net 175 to temporarily filter out harmful insects suctioned and moved through the capturing tube unit 160 so as to acquire an instantaneous image of the harmful insects before the harmful insects are filtered by the catch net 175. The capture unit 300 includes a rotatable net 310 provided to the capturing tube unit 160 so as to rotate at a certain frequency, and a rotation drive unit 320, such as a servomotor, for rotatably driving the rotatable net 310 at the certain frequency under control of the controller 400.

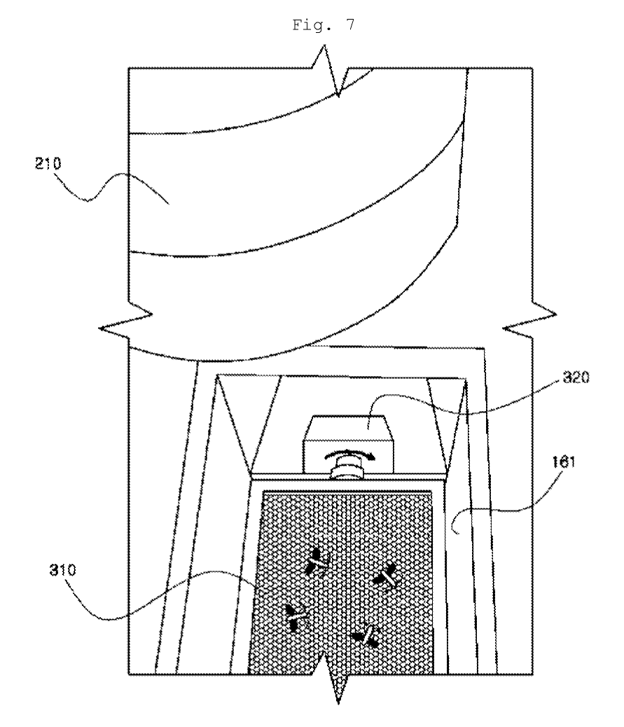

Accordingly, by rotational driving of the rotation drive unit 320, the rotatable net 310 is disposed horizontally to block the guide tube, and is vertically rotated from the capture position where the harmful insects are temporarily filtered out to a discharge position where the harmful insects are discharged to the catch net 175. Thereby, as shown in FIG. 7, an image of the collected harmful insects may be easily acquired in real time by the imaging unit 200 without an expensive high-speed camera when the rotatable net 310 is at the capture position, such that classification and analysis of the harmful insects by frequency of occurrence and kind can be easily performed.

As shown in FIG. 6, in an embodiment of the present invention, the rotatable net 310 is installed at a position on the lower surface of the upper casing of the capturing analyzer 130 provided with the capturing tube unit 160. The guide tube 161 is exposed to the discharge port 165 at this position, and the rotation drive unit 320 is installed on the lower surface of the upper casing of the capturing analyzer 130 so as to be connected to one side of the rotatable net 310.

Preferably, the controller 400 for controlling operation of the suction fan 177 of the catch unit 170, which will be described later, the imaging unit 200 and the rotation drive unit 320 is provided in the upper casing of the capturing analyzer 130 in the smart collection body 100 according to the present invention, as shown in FIGS. 6 and 9.

The controller 400 may control the operation of the suction fan 177 to control suction and collection of harmful insects and control the imaging camera 210 and the illumination lamp 220 of the imaging unit 200 to perform imaging at certain time intervals according to a time cycle in which the rotatable net 310 rotates, and control rotational driving of the rotation drive unit 320 to control the rotatable net 310 to rotate at the certain frequency.

In an embodiment of the present invention, the controller 400 preferably controls the rotation drive unit 320 through a timer 401 to rotate the rotatable net 310 at the certain frequency.

Thereby, the controller 400 may easily control the imaging camera 210 and the illumination lamp 220 of the imaging unit 200 through the timer 401 to perform imaging at certain time intervals according to a frequency at which the rotatable net 310 rotates, may also easily control the rotational driving of the rotation drive unit 320 to rotate the rotatable net 310 at the certain frequency.

More specifically, the controller 400 controls the rotation drive unit 320 of the capture unit 300 through the timer 401 to rotate the rotatable net 310 from the discharge position to the capture position at a certain frequency.

That is, the rotatable net 310 is allowed to rotate in only one direction such that the rotatable net 310 continuously rotates from the discharge position to the capture position and then from the capture position to the discharge position at a certain frequency.

At this time, the controller 400 preferably controls the imaging camera 210 and the illumination lamp 220 of the imaging unit 200 through the timer 401 to capture images of harmful insects temporarily collected in the rotatable net 310 whenever the rotatable net 310 is at the capture position.

Once an image of the harmful insects temporarily collected in the rotatable net 310 is captured by the imaging camera 210 of the imaging unit 200, the rotatable net 310 is rotated again from the capture position to the discharge position by rotational driving of the rotation drive unit 320, and the harmful insects which have been temporarily captured in the upper portion of the rotatable net 310 are discharged to the upper portion of the catch net 175 of the catch unit 170 and finally filtered by the catch net 175.

In another embodiment of the present invention, the timer 401 may control the imaging unit 200 and the rotation drive unit 320 to operate at a certain frequency even if there is no separate control signal from the controller 400.

In an embodiment of the present invention, the controller 400 preferably includes an input unit 410 for receiving data required by the controller 400 including the certain frequency at which the rotatable net 310 rotates and transmitting the same to the controller 400, and a storage unit 420 for receiving, from the controller 400, the data received from the input unit 410 and storing the data, as shown in FIG. 9.

The storage unit 420 may store the count information and image information on harmful insects acquired by the counting sensor 167 and the imaging camera 210 and transmit the same to the first communication unit 180 or to a separate memory means such as a USB memory carried by an administrator.

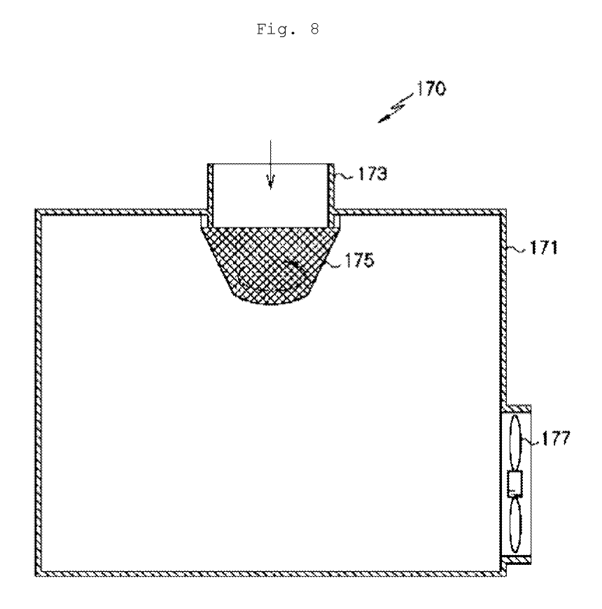

As shown in FIGS. 1 and 8, the catch unit 170 causes harmful insects collected in the collection unit 110 to be suctioned and moved thereinto via the outer filter 140, the inner filter 150, and the capturing tube unit 160, and includes a catch housing 171, a fourth introduction port 173, a catch net 175, and a suction fan 177.

The catch housing 171 forms an outer appearance of the catch unit 170 and defines a predetermined accommodation space therein, and the fourth introduction port 173 is connected to the third discharge port 165 of the guide tube 161 of the catching tube unit 160 to provide an inlet through which harmful insects moved through the guide tube 161 and discharged through the third discharge port 165 are introduced into the accommodation space of the catch housing 171.

The catch net 175 is formed in a net structure to finally collect the harmful insects introduced into the accommodation space of the catch housing 171 and is arranged to surround an end of the fourth introduction port 173 in the accommodation space of the catch housing 171.

The suction fan 177 is installed on one side of the catch housing 171 to suction the air from the accommodation space of the catch housing 171 and discharges the air to the outside of the accommodation space such that the harmful insects introduced into the accommodation space of the catch housing 171 are guided to the catch net 175.

Accordingly, as the air in the accommodation space of the catch housing 171 is discharged to the outside by the suction force of the suction fan 177, harmful insects introduced through the fourth introduction port 173 may be caught and collected by the catch net 175.

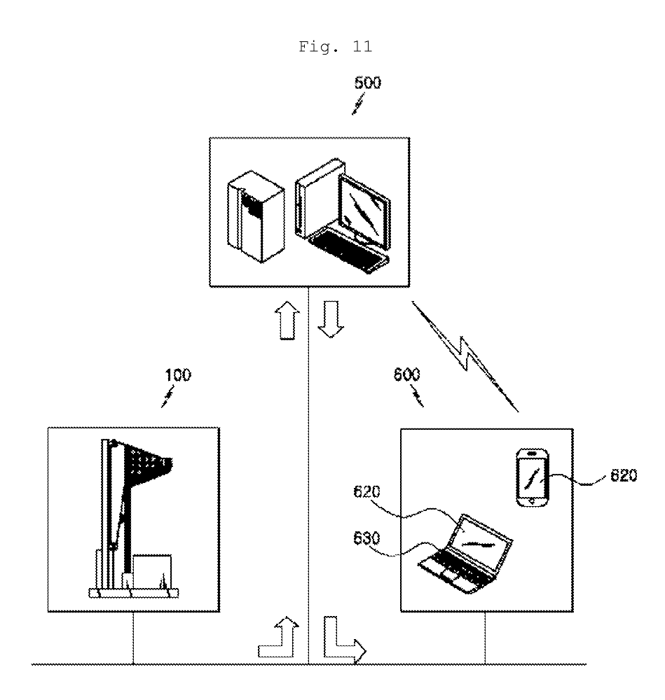

Meanwhile, the insect capturing device having an imaging function for harmful insect information management according to the present invention may further include a server 500 and a terminal 600, as shown in FIGS. 10 and 11.

Thereby, a system including a plurality of smart collection bodies 100, 100′, . . . which are installed one by one in each region and remotely monitored and measured by the server 500 using multiple administrator terminals 600, 600′, . . . through wired or wireless communication over a communication network 1 such as the Internet may be configured, as shown in FIG. 10.

In this case, each of the smart collection bodies 100 and 100′ is provided with the first communication unit 180 for transmitting data to the server 500 as well as the controller 400 in a wired/wireless communication manner, and the server 500 may include a security module for authenticating access to the server 500 when multiple administrator terminals 600, 600′, . . . attempt to access the server 500.

Accordingly, collection images of harmful insects collected in each region, classification information on the collected harmful insects, information on the population of the collected harmful insects, and the like may be collected by the server 500, such that the distribution information on the harmful insects in each region may be easily remotely monitored and measured by a central control station. The server 500 may transmit the distribution information to the plurality of administrator terminals 600, 600′, . . . and allow only the administrator terminal 600 authenticated through the authentication process to remotely access the sever 500, such that the multiple administrator terminals 600 distributed nationwide can easily remotely monitor and measure the distribution status of the collected harmful insects in each region.

As shown in FIG. 10, the server 500, which functions to integrally store and manage harmful insect information on the harmful insects collected in the smart collection body 100, includes a second communication unit 510 for receiving count information and image information on harmful insects by wired/wireless communication, and a memory unit 520 for receiving and storing the information from the second communication unit 510.

The second communication unit 510 may transmit the count information and image information on the harmful insects stored in the memory unit 520 to the terminal 600 or receive information from the outside. For example, the second communication unit 510 may receive harmful insect information from the first communication unit 180 of the smart collection body 100, and transmit the harmful insect information stored in the memory unit 520 to the terminal 600.

The memory unit 520 functions as a storage medium and may store, for example, the count information and image information transmitted from the first communication unit 180. Accordingly, by storing, in the memory unit 520, the harmful insect information transmitted from multiple smart collection bodies 100, 100′, . . . installed in the regions separated from each other, the harmful insect information collected from the multiple smart collection bodies 100, 100′, . . . may be integrally managed.

As shown in FIGS. 10 and 11, the terminal 600 may be connected to the server 500 to receive the count information and image information stored in the server 500, and a control signal of the smart collection body 100 may be remotely input therethrough. The terminal 600 includes a third communication unit 610 for receiving, by wired/wireless communication, the count information and image information on the harmful insects transmitted from the second communication unit 510, a display unit 620 for outputting an image representing the information received from the third communication unit 610, and a terminal input unit 630.

The type of the terminal 600 is not particularly limited and may include, for example, a cellular phone, a smartphone, a notebook computer, a PDA (Personal Digital Assistant), and a PMP (Portable Multimedia Player).

Information may be exchanged between the terminal 600 and the server 500 or between the terminal 600 and the smart collection body 100 via the third communication unit 610. For example, the third communication unit 610 may receive the count information and the image information transmitted by the second communication unit 510 of the server 500, and store the received count information and image information in the storage unit of the terminal 600.

The display unit 620 may output an image representing the information processed by the terminal 600. For example, the display unit 620 may output an image representing the count information and image information received from the third communication unit 610 and provide the same to the administrator.

Accordingly, the administrator may remotely check the count information and the image information collected from the smart collection body 100 through the terminal 600, even at a place far away from the smart collection body 100. As a result, one user can check the count information and the image information collected from the plurality of smart collection bodies 100, 100′, . . . through the terminal 600 without having to travel around the various regions, and therefore the labor required to check the count information and the image information collected from the smart collection bodies 100, 100′, . . . may be reduced.

The display unit 620 is not limited to a particular type, but may employ at least one of a liquid crystal display (LCD), a thin film transistor-liquid crystal display (TFT LCD), an organic light emitting diode (OLED), a flexible display, and a 3D display.

The terminal input unit 630 may generate input data for controlling the operation of the terminal 600 by the user. The terminal input unit 630 is not limited to a particular type, but may include, for example, a key pad dome switch, a jog wheel, and a jog switch.

In addition, when the display unit 620 and a sensor for sensing a touch operation (hereinafter, referred to as “touch sensor”) form a mutual layer structure (hereinafter, referred to as a “touch screen”), the display unit 620 may function as an input device. The touch sensor may take the form of, for example, a touch film, a touch sheet, a touch pad, or the like.

As the terminal 600 is provided with the terminal input unit 630, a control signal for controlling driving of the smart collection body 100 may be input through the terminal input unit 630. For example, the ON/OFF control signals for the counting sensor 167, the imaging camera 210, the illumination lamp 220, the rotation drive unit 320, the suction fan 177, and the like may be input through the terminal input unit 630 to remotely control driving of the counting sensor 167, the imaging camera 210, the illumination lamp 220, the rotation drive unit 320, and the suction fan 177.

That is, the control signal input by the terminal input unit 630 may be directly transmitted from the third communication unit 610 of the terminal 600 to the first communication unit 180 of the smart collection body 100, or may be sequentially transmitted from the third communication unit 610 of the terminal 600 to the second communication unit 510 of the server 500 and the first communication unit 180 of the smart collection body 100.

Thereby, the controller 400 of the smart collection body 100 may control driving of the smart collection body 100 according to a control signal input through the terminal input unit 630. As a result, it becomes unnecessary to visit the installation place of the smart collection body 100 to control driving of the smart collection body 100, and one administrator can use the terminal 600 to control driving of the plurality of smart collection bodies 100, 100′, . . . ). Accordingly, labor required for management of the smart collection bodies 100, 100′, . . . may be reduced.

FIG. 11 is a general conceptual diagram of an insect capturing device having an imaging function for harmful insect information management according to an embodiment of the present invention.

Referring to FIG. 11, an insect capturing device having an imaging function for harmful insect information management according to the present invention includes a smart collection body 100 capable of capturing harmful insects and collecting information on the captured harmful insects, a server 500 capable of storing and managing the harmful insect information collected by the smart collection body 100, and a terminal 600 capable of receiving the harmful insect information from the server 500.

Accordingly, the harmful insect information may be collected and transmitted by the smart collection body 100, and may be remotely managed by the server 500 and the terminal 600.

Thus, according to the present invention, there may be provided an insect capturing device having an imaging function for harmful insect information management, which has an improved structure to automatically collect and remotely provide harmful insect information about harmful insects such as flies and mosquitoes trapped in smart collectors.

While the present invention has been described above in connection with the accompanying drawings, it will be understood by those skilled in the art that the invention is not limited to the disclosed embodiments, but, on the contrary, various changes and modifications may be made therein without departing from the spirit and scope of the invention as defined by the appended claims.

### DESCRIPTION OF REFERENCE NUMERALS

110: Collection unit 111: Collection net

115: Passage tube 120: Support

130: Capturing analyzer 140: Outer filter

150: Inner filter 160: Capturing tube unit

167: Counting sensor 170: Catch unit

175: Catch net 180: First communication unit

200: Imaging unit 210: Imaging camera

220: Illumination lamp 300: Capture unit

310: Rotatable net 320: Rotation drive unit

500: Server 510: Second communication unit

520: Memory unit 600: Terminal

610: Third communication unit 620: Display unit

What is claimed is:

1. An insect capturing device having a imaging function for harmful insect information management, the insect capturing device comprising:
a collection unit having a collection net for collecting harmful insects, one side of the collection net being provided with a passage tube through which the collected harmful insects pass;
a support provided on the other side of the collection unit to support the collection unit;
a capturing analyzer comprising: an outer filter connected to the collection unit through the passage tube to separate moisture from air introduced together with the harmful insects; an inner filter connected to the outer filter and configured to maintain constant temperature and humidity conditions; a capturing tube unit connected to the inner filter and provided with a counting sensor for sensing the harmful insects passing therethrough and counting the number of the harmful insects; and a catch unit connected to the capturing tube unit and provided with a catch net so as to finally filter out the harmful insects suctioned and moved through the capturing tube unit;
an imaging unit provided at a position in the capturing tube unit facing the catch unit; and
a capture unit provided between the imaging unit and the catch net to temporarily filter out the harmful insects suctioned and moved through the capturing tube unit so as to acquire an image of the harmful insects before the harmful insects are filtered by the catch net.

2. The insect capturing device according to claim 1, wherein
the capture unit comprises:
a rotatable net provided to the capturing tube unit so as to rotate at a certain frequency; and
a rotation drive unit for rotatably driving the rotatable net.

3. The insect capturing device according to claim 2, wherein
the imaging unit comprises:
an imaging camera for performing imaging at predetermined time intervals according to the certain frequency of rotation of the rotatable net; and
an illumination lamp arranged around the imaging camera.

4. The insect capturing device according to claim 2, wherein
the capturing analyzer comprises a first communication unit for transmitting, by wired/wireless communication, count information and image information on the harmful insects acquired from the imaging unit,
the insect capturing device further comprising:
a server comprising a second communication unit for receiving, by wired/wireless communication, the count information and image information on the harmful insects transmitted from the first communication unit, and a memory unit for receiving and storing the information received from the second communication unit.

5. The insect capturing device according to claim 4, wherein
the second communication unit transmits the count information and the image information on the harmful insects stored in the memory unit,
the insect capturing device further comprising a server comprising:
a third communication unit for receiving, by wired/wireless communication, the count information and the image information on the harmful insects transmitted from the second communication unit; and
a display unit for outputting an image corresponding to the information received from the third communication unit.

6. The insect capturing device according to claim 1, wherein
the capturing tube unit comprises a guide tube for guiding movement of the harmful insects,
wherein the counting sensor is provided inside the guide tube, and the guide tube is formed of a transparent material.

7. The insect capturing device according to claim 2, wherein
the capturing tube unit comprises a guide tube for guiding movement of the harmful insects,
wherein the counting sensor is provided inside the guide tube, and the guide tube is formed of a transparent material.

8. The insect capturing device according to claim 3, wherein
the capturing tube unit comprises a guide tube for guiding movement of the harmful insects,
wherein the counting sensor is provided inside the guide tube, and the guide tube is formed of a transparent material.

9. The insect capturing device according to claim 4, wherein
the capturing tube unit comprises a guide tube for guiding movement of the harmful insects,
wherein the counting sensor is provided inside the guide tube, and the guide tube is formed of a transparent material.

10. The insect capturing device according to claim 5, wherein
the capturing tube unit comprises a guide tube for guiding movement of the harmful insects,
wherein the counting sensor is provided inside the guide tube, and the guide tube is formed of a transparent material.
